(19) United States
(12) Patent Application Publication
(10) Pub. No.: US 2021/0072977 A1
(43) Pub. Date: Mar. 11, 2021

(54) SYSTEMS AND METHODS FOR HOSTING MULTIPLE FIRMWARE IMAGES

(71) Applicant: Dell Products L.P., Round Rock, TX (US)

(72) Inventors: Prashanth GIRI, Round Rock, TX (US); Murali K. SOMAROUTHU, Austin, TX (US)

(73) Assignee: Dell Products L.P., Round Rock, TX (US)

(21) Appl. No.: 16/567,897

(22) Filed: Sep. 11, 2019

(51) Int. Cl. G06F 8/658; G06F 8/61; G06F 8/71

(52) U.S. Cl. CPC G06F 8/658; G06F 8/71; G06F 8/63

(57) ABSTRACT

An information handling system may include a host system comprising a host system processor and an information handling resource communicatively coupled to the host system processor and configured to manage firmware versions of the information handling resource by, in response to receiving a firmware update image: (i) comparing the firmware update image to an existing version of firmware of the information handling resource; (ii) storing differences between the firmware update image and the existing version of firmware of the information handling resource as a firmware patch image; and (iii) applying the firmware update image to the existing version of firmware of the information handling resource as a firmware patch image to emulate the firmware update image.

### TECHNICAL FIELD

The present disclosure relates in general to information handling systems, and more particularly to methods and systems for hosting multiple firmware images, for example within a management controller of an information handling system.

### BACKGROUND

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Various components of the an information handling system may include firmware. Firmware is a type of software that provides control, monitoring, and data manipulation of electronic components, such as those used in information handling systems. Like other types of software, firmware is susceptible to corruption.

In general, for an embedded systems-based device running Linux or Linux-based operating systems, the firmware is built, bundled, and deployed as a single monolithic image rather than individual applications or files. The main reason behind adopting such a methodology is because the device generally has a read-only file system (e.g., squashfs) which can be updated entirely or not at all. Having a read-only file system has several advantages (less susceptibility to corruption, secure, space saving, etc.) compared to a read-write file system in an embedded systems environment.

Using existing approaches, an end device typically has two partitions (an active partition and a standby partition) that hosts a current version and a previous version of firmware respectively. Whenever a firmware update is initiated on the device, it overwrites/updates the standby partition with the latest image and boots from it. In any case, the update will end up replacing the standby partition completely and boot from it. If the device needs to roll back to a previous version of the firmware, the user may have to initiate update of the device with older firmware (if the desired version is not already on the standby partition of the device). Thus, using existing approaches, at any time, there are only two versions (active and standby) of the firmware available on the system, which limits the number of firmware versions the device can be switched between without flashing a new image to one of the partitions.

Although it is technically possible to create multiple partitions instead of just two on a device's storage which may host multiple versions of the firmware and the device may be made to switch between these firmware images, such a solution may be highly impractical from cost and implementation point of view.

### SUMMARY

In accordance with the teachings of the present disclosure, the disadvantages and problems associated with existing approaches for storing multiple versions of firmware images may be reduced or eliminated.

In accordance with embodiments of the present disclosure, an information handling system may include a host system comprising a host system processor and an information handling resource communicatively coupled to the host system processor and configured to manage firmware versions of the information handling resource by, in response to receiving a firmware update image: (i) comparing the firmware update image to an existing version of firmware of the information handling resource; (ii) storing differences between the firmware update image and the existing version of firmware of the information handling resource as a firmware patch image; and (iii) applying the firmware update image to the existing version of firmware of the information handling resource as a firmware patch image to emulate the firmware update image.

In accordance with these and other embodiments of the present disclosure, a method for managing firmware versions of an information handling resource may include, in response to receiving a firmware update image: (i) comparing the firmware update image to an existing version of firmware of the information handling resource; (ii) storing differences between the firmware update image and the existing version of firmware of the information handling resource as a firmware patch image; and (iii) applying the firmware update image to the existing version of firmware of the information handling resource as a firmware patch image to emulate the firmware update image.

In accordance with these and other embodiments of the present disclosure, an article of manufacture may include a non-transitory computer-readable medium and computer-executable instructions carried on the computer-readable medium, the instructions readable by a processor, the instructions, when read and executed, for causing the processor to manage firmware versions of an information handling resource by, in response to receiving a firmware update image: (i) compare the firmware update image to an existing version of firmware of the information handling resource; (ii) store differences between the firmware update image and the existing version of firmware of the information handling resource as a firmware patch image; and (iii) apply the firmware update image to the existing version of firmware of the information handling resource as a firmware patch image to emulate the firmware update image.

Technical advantages of the present disclosure may be readily apparent to one skilled in the art from the figures, description and claims included herein. The objects and advantages of the embodiments will be realized and achieved at least by the elements, features, and combinations particularly pointed out in the claims.

It is to be understood that both the foregoing general description and the following detailed description are examples and explanatory and are not restrictive of the claims set forth in this disclosure.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 illustrates a block diagram of an example information handling system, in accordance with embodiments of the present disclosure;

FIG. 2 illustrates a flowchart of an example method for generating a firmware patch image, in accordance with embodiments of the present disclosure; and

FIG. 3 illustrates a graphical representation of the Linux overlay mechanism as used to apply firmware patch images to existing firmware versions, in accordance with embodiments of the present disclosure.

### DETAILED DESCRIPTION

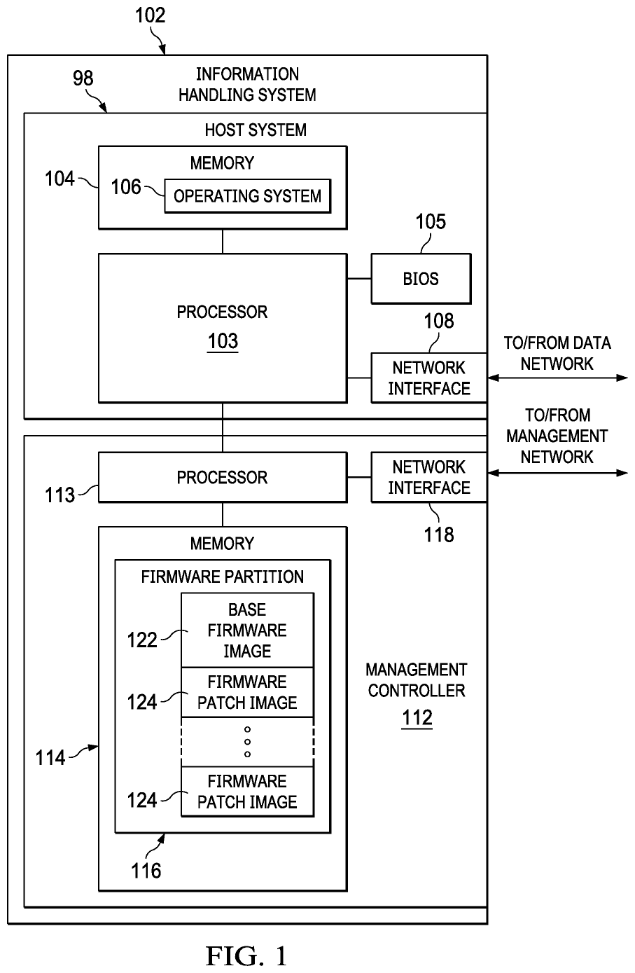

Preferred embodiments and their advantages are best understood by reference to FIGS. 1 through 3, wherein like numbers are used to indicate like and corresponding parts.

For the purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, an information handling system may be a personal computer, a personal digital assistant (PDA), a consumer electronic device, a network storage device, or any other suitable device and may vary in size, shape, performance, functionality, and price. The information handling system may include memory, one or more processing resources such as a central processing unit (“CPU”) or hardware or software control logic. Additional components of the information handling system may include one or more storage devices, one or more communications ports for communicating with external devices as well as various input/output (“I/O”) devices, such as a keyboard, a mouse, and a video display. The information handling system may also include one or more buses operable to transmit communication between the various hardware components.

For the purposes of this disclosure, computer-readable media may include any instrumentality or aggregation of instrumentalities that may retain data and/or instructions for a period of time. Computer-readable media may include, without limitation, storage media such as a direct access storage device (e.g., a hard disk drive or floppy disk), a sequential access storage device (e.g., a tape disk drive), compact disk, CD-ROM, DVD, random access memory (RAM), read-only memory (ROM), electrically erasable programmable read-only memory (EEPROM), and/or flash memory; as well as communications media such as wires, optical fibers, microwaves, radio waves, and other electromagnetic and/or optical carriers; and/or any combination of the foregoing.

For the purposes of this disclosure, information handling resources may broadly refer to any component system, device or apparatus of an information handling system, including without limitation processors, service processors, basic input/output systems, buses, memories, I/O devices and/or interfaces, storage resources, network interfaces, motherboards, and/or any other components and/or elements of an information handling system.

FIG. 1 illustrates a block diagram of an example information handling system 102, in accordance with embodiments of the present disclosure. In some embodiments, information handling system 102 may comprise a personal computer. In some embodiments, information handling system 102 may comprise or be an integral part of a server. In other embodiments, information handling system 102 may comprise a portable information handling system (e.g., a laptop, notebook, tablet, handheld, smart phone, personal digital assistant, etc.). As depicted in FIG. 1, information handling system 102 may include a processor 103, a memory 104 communicatively coupled to processor 103, a BIOS 105 communicatively coupled to processor 103, a network interface 108 communicatively coupled to processor 103, and a management controller 112 communicatively coupled to processor 103. In operation, processor 103, memory 104, BIOS 105, and network interface 108 may comprise at least a portion of a host system 98 of information handling system 102.

Processor 103 may include any system, device, or apparatus configured to interpret and/or execute program instructions and/or process data, and may include, without limitation, a microprocessor, microcontroller, digital signal processor (DSP), application specific integrated circuit (ASIC), or any other digital or analog circuitry configured to interpret and/or execute program instructions and/or process data. In some embodiments, processor 103 may interpret and/or execute program instructions and/or process data stored in memory 104 and/or another component of information handling system 102.

Memory 104 may be communicatively coupled to processor 103 and may include any system, device, or apparatus configured to retain program instructions and/or data for a period of time (e.g., computer-readable media). Memory 104 may include RAM, EEPROM, a PCMCIA card, flash memory, magnetic storage, opto-magnetic storage, or any suitable selection and/or array of volatile or non-volatile memory that retains data after power to information handling system 102 is turned off.

As shown in FIG. 1, memory 104 may have stored thereon an operating system 106. Operating system 106 may comprise any program of executable instructions, or aggregation of programs of executable instructions, configured to manage and/or control the allocation and usage of hardware resources such as memory, processor time, disk space, and input and output devices, and provide an interface between such hardware resources and application programs hosted by operating system 106. In addition, operating system 106 may include all or a portion of a network stack for network communication via a network interface (e.g., network interface 108 for communication over a data network). Active portions of operating system 106 may be transferred to memory 104 for execution by processor 103. Although operating system 106 is shown in FIG. 1 as stored in memory 104, in some embodiments operating system 106 may be stored in storage media accessible to processor 103, and active portions of operating system 106 may be transferred from such storage media to memory 104 for execution by processor 103.

A BIOS 105 may include any system, device, or apparatus configured to identify, test, and/or initialize information handling resources of information handling system 102, and/or initialize interoperation of information handling system 102 with other information handling systems. “BIOS” may broadly refer to any system, device, or apparatus configured to perform such functionality, including without limitation, a Unified Extensible Firmware Interface (UEFI). In some embodiments, BIOS 105 may be implemented as a program of instructions that may be read by and executed on processor 103 to carry out the functionality of BIOS 105. In these and other embodiments, BIOS 105 may comprise boot firmware configured to be the first code executed by processor 103 when information handling system 102 is booted and/or powered on. As part of its initialization functionality, code for BIOS 105 may be configured to set components of information handling system 102 into a known state, so that one or more applications (e.g., an operating system or other application programs) stored on compatible media (e.g., disk drives) may be executed by processor 103 and given control of information handling system 102.

Network interface 108 may comprise any suitable system, apparatus, or device operable to serve as an interface between information handling system 102 and one or more other information handling systems via an in-band management network. Network interface 108 may enable information handling system 102 to communicate using any suitable transmission protocol and/or standard. In these and other embodiments, network interface 108 may comprise a network interface card, or “NIC.” In some embodiments, network interface 108 may comprise a 10 gigabit Ethernet network interface. In these and other embodiments, network interface 108 may be enabled as a local area network (LAN)-on-motherboard (LOM) card. In these and other embodiments, processor 103 and network interface 108 may be coupled via any suitable interface, including without limitation a Peripheral Component Interconnect Express (PCIe) bus/interface.

Management controller 112 may be configured to provide management facilities for management of information handling system 102. Such management may be made by management controller 112 even if information handling system 102 is powered off or powered to a standby state. Management controller 112 may include a processor 113, memory 114, and a management network interface 118 separate from and physically isolated from data network interface 108. In certain embodiments, management controller 112 may include or may be an integral part of a baseboard management controller (BMC) or a remote access controller (e.g., a Dell Remote Access Controller or Integrated Dell Remote Access Controller).

Processor 113 may include any system, device, or apparatus configured to interpret and/or execute program instructions and/or process data, and may include, without limitation, a microprocessor, microcontroller, digital signal processor (DSP), application specific integrated circuit (ASIC), or any other digital or analog circuitry configured to interpret and/or execute program instructions and/or process data. In some embodiments, processor 113 may interpret and/or execute program instructions and/or process data stored in memory 114 and/or another component of information handling system 102 or management controller 112. As shown in FIG. 1, processor 113 may be communicatively coupled to processor 103. Such coupling may be via a Universal Serial Bus (USB), System Management Bus (SMBus), and/or one or more other communications channels.

Memory 114 may be communicatively coupled to processor 113 and may include any system, device, or apparatus configured to retain program instructions and/or data for a period of time (e.g., computer-readable media). Memory 114 may include RAM, EEPROM, a PCMCIA card, flash memory, magnetic storage, opto-magnetic storage, or any suitable selection and/or array of volatile or non-volatile memory that retains data after power to management controller 112 is turned off.

As shown in FIG. 1, memory 114 may include a firmware partition 116 for storing firmware. Firmware may comprise any program of executable instructions, or aggregation of programs of executable instructions, configured to, when executed, provide control, monitoring, and/or data manipulation of electronic components of management controller 112 in order to perform the functionality of management controller 112. As shown in FIG. 1, firmware may comprise a base firmware image 122 plus one or more firmware patch images 124, as described in greater detail below. A base firmware image 122 may comprise an original or factory-shipped version of firmware, while each firmware patch image 124 may represent differences between a current firmware version from which such firmware patch image 124 was generated and a previous version of firmware.

Although firmware is shown in FIG. 1 as stored in memory 114, in some embodiments firmware may be stored in storage media accessible to processor 113, and active portions of firmware may be transferred from such storage media to memory 114 for execution by processor 113.

Network interface 118 may comprise any suitable system, apparatus, or device operable to serve as an interface between management controller 112 and one or more other information handling systems via an out-of-band management network. Network interface 118 may enable management controller 112 to communicate using any suitable transmission protocol and/or standard. In these and other embodiments, network interface 118 may comprise a network interface card, or “NIC.” In some embodiments, network interface 118 may comprise a 1 gigabit Ethernet network interface.

In addition to processor 103, memory 104, network interface 108, and management controller 112, information handling system 102 may include one or more other information handling resources.

As described in more detail herein, management controller 112 and firmware partition 116 may be configured to host multiple versions of firmware without consuming extra storage resources that are otherwise needed for parallel hosting of firmware versions using traditional approaches. Accordingly, rather than hosting full firmware images using traditional approaches, management controller 112 may be configured to create dynamic firmware patch images 124 during a firmware update process, wherein each firmware patch image 124 includes differences between an updated firmware image and a previous firmware image (wherein the previous firmware image comprises base firmware image 122 plus previous firmware patch images 124, if present), as described with respect to method 200 below.

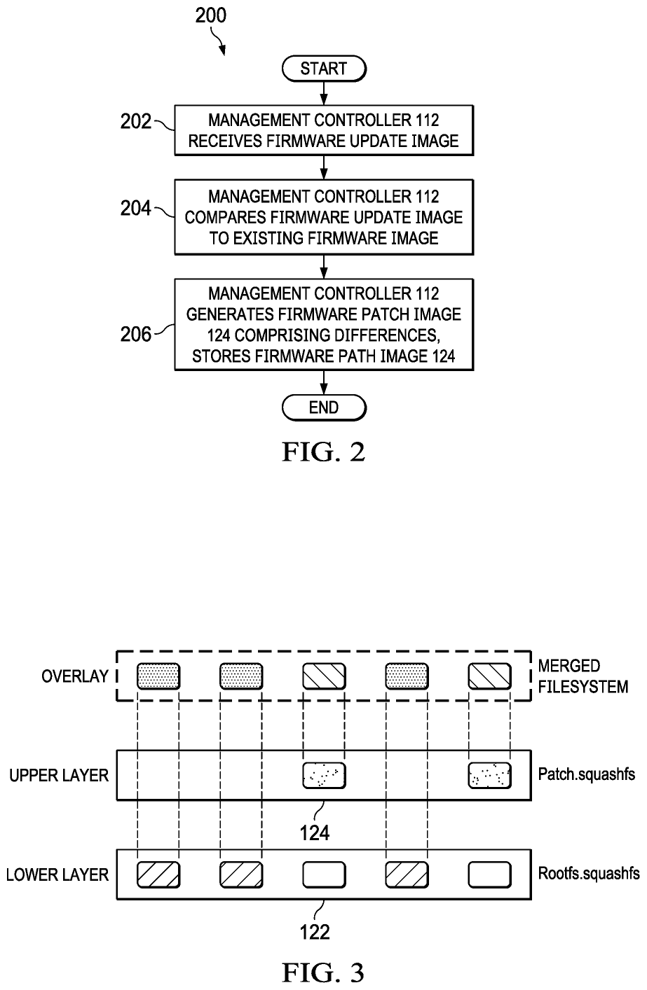

FIG. 2 illustrates a flowchart of an example method 200 for generating a firmware patch image 124, in accordance with embodiments of the present disclosure. According to some embodiments, method 200 may begin at step 202. As noted above, teachings of the present disclosure may be implemented in a variety of configurations of information handling system 102.

At step 202, management controller 112 may receive a firmware update image to update an existing firmware version on firmware partition 116. If the firmware update image comprises the first update of the firmware, the existing firmware version may comprise only base firmware image 122 and no firmware patch images 124. For later updates of the firmware (e.g., other than the first update), the existing firmware version may comprise base firmware image 122 and one or more firmware patch images 124, wherein each firmware patch image 124 is a difference between: (i) a firmware update image from which such firmware patch image 124 is generated and (ii) a previous version of firmware. Thus, in some instances, an existing firmware version may comprise only base firmware image 122 and no firmware patch images 124, while in some instances, an existing firmware image may comprise an “effective” firmware image comprising firmware image 122 and one or more firmware patch images 124.

At step 204, management controller 112 may compare the firmware update image to the existing firmware image to determine the differences between the firmware update image and the existing firmware image. Such comparison may be made using any suitable file comparison tool (diff, bsdiff, courgette, etc.).

At step 206, management controller 112 may generate a firmware patch image 124 comprising such differences, and store such firmware path image 124 as a new firmware patch image 124 to firmware partition 116. The resulting firmware patch image 124 may hold only files updated in the firmware update.

After step 206, method 200 may end.

Although FIG. 2 discloses a particular number of steps to be taken with respect to method 200, method 200 may be executed with greater or lesser steps than those depicted in FIG. 2. In addition, although FIG. 2 discloses a certain order of steps to be taken with respect to method 200, the steps comprising method 200 may be completed in any suitable order.

Method 200 may be implemented using information handling system 102 or any other system operable to implement method 200. In certain embodiments, method 200 may be implemented partially or fully in software and/or firmware embodied in computer-readable media.

In operation, a new firmware patch image 124 created from a firmware update image may be applied to an existing firmware version of firmware partition 116, such that the combination of the existing firmware version and the new firmware patch image 124 is identical to the firmware update image both functionally and at the file level. Similarly, a rollback from a current firmware version to a previous firmware version may be accomplished by simply removing (or disabling) one or more firmware patch images 124. For example, a user (e.g., an administrator) of information handling system 102 may be able to, via a graphical user interface or other management interface, select a firmware version to roll back to, and management controller 112 may respond by deleting or disabling one or more firmware patch images 124 to return to such firmware version. In addition, multiple firmware patch images 124 may be stacked upon one another to represent multiple firmware versions.

Although any suitable mechanism may be used to apply one or more firmware patch images 124 to base firmware image 122 to arrive at a firmware version, one mechanism that may be used in an embedded Linux-based firmware file system is “overlaying.” The Linux overlay mechanism allows a secondary file system to be overlaid on top of an existing file system. This stacking of the file systems creates a compounding effect with results that are a combination of both individual file systems in the stack. FIG. 3 illustrates a graphical representation of the Linux overlay mechanism, in accordance with embodiments of the present disclosure. As shown in FIG. 3, a lower layer which may comprise base firmware image 122 (and may comprise rootfs.squashfs in the Linux file system), may be overlaid by an upper layer which may comprise a firmware patch image 124 (and may comprise a file patch.squashfs in the Linux file system). When overlaid in such manner, a file present in the upper layer would take precedence (e.g., mask) over the same file in the lower layer, which may result in an effective virtual overwrite of the existing binaries of the older base firmware image 122 with the newer firmware patch image 124 from the upper layer, resulting in a merged file system equivalent to the firmware update from which the firmware patch image 124 was created. Such overlay mechanism may thus emulate dynamic patching of the files on the fly.

Thus, after a firmware patch image 124 is successfully created, on a subsequent boot of management controller 112, management controller 112 may mount a firmware patch image 124 over base firmware image 122 (and may mount other firmware patch images 124 over other firmware patch images 124), such that in effect, the firmware update from which the firmware patch image 124 is created is executed as the firmware for management controller 112.

To downgrade or roll back to a previous firmware version, management controller 112 may mark the relevant firmware patch image 124 for reversion and management controller 112 may be rebooted. On such subsequent boot, with the firmware patch image 124 marked for reversion, it may be ignored and thus not applied to the overlay, such that an older firmware image is effectively booted.

As used herein, when two or more elements are referred to as “coupled” to one another, such term indicates that such two or more elements are in electronic communication or mechanical communication, as applicable, whether connected indirectly or directly, with or without intervening elements.

This disclosure encompasses all changes, substitutions, variations, alterations, and modifications to the example embodiments herein that a person having ordinary skill in the art would comprehend. Similarly, where appropriate, the appended claims encompass all changes, substitutions, variations, alterations, and modifications to the example embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative. Accordingly, modifications, additions, or omissions may be made to the systems, apparatuses, and methods described herein without departing from the scope of the disclosure. For example, the components of the systems and apparatuses may be integrated or separated. Moreover, the operations of the systems and apparatuses disclosed herein may be performed by more, fewer, or other components and the methods described may include more, fewer, or other steps. Additionally, steps may be performed in any suitable order. As used in this document, “each” refers to each member of a set or each member of a subset of a set.

Although exemplary embodiments are illustrated in the figures and described below, the principles of the present disclosure may be implemented using any number of techniques, whether currently known or not. The present disclosure should in no way be limited to the exemplary implementations and techniques illustrated in the drawings and described above.

Unless otherwise specifically noted, articles depicted in the drawings are not necessarily drawn to scale.

All examples and conditional language recited herein are intended for pedagogical objects to aid the reader in understanding the disclosure and the concepts contributed by the inventor to furthering the art, and are construed as being without limitation to such specifically recited examples and conditions. Although embodiments of the present disclosure have been described in detail, it should be understood that various changes, substitutions, and alterations could be made hereto without departing from the spirit and scope of the disclosure.

Although specific advantages have been enumerated above, various embodiments may include some, none, or all of the enumerated advantages. Additionally, other technical advantages may become readily apparent to one of ordinary skill in the art after review of the foregoing figures and description.

To aid the Patent Office and any readers of any patent issued on this application in interpreting the claims appended hereto, applicants wish to note that they do not intend any of the appended claims or claim elements to invoke 35 U.S.C. § 112(f) unless the words “means for” or “step for” are explicitly used in the particular claim.

1. An information handling system comprising:
a host system comprising a host system processor; and
an information handling resource communicatively coupled to the host system processor wherein the information handling resource includes a second processor, coupled to a second memory, wherein the second memory includes processor executable instructions that, when executed by the second processor, cause the second processor to perform operations responsive to receiving a new firmware version, wherein the operations include:
comparing the new firmware version to an existing firmware version;
storing differences between the new firmware version and the existing firmware version as a firmware patch image; and
applying the firmware patch image to the existing version of firmware version to emulate the new firmware version, wherein applying the firmware patch image to the existing firmware version comprises overlaying a first file system associated with the new firmware version on a second file system associated with the existing firmware version, wherein an instance of a particular file present in the first file system takes precedence over an instance of the particular file in the lower layer.

2. The information handling system of claim 1, wherein the operations include:
managing firmware versions of the information handling resource by maintaining a firmware partition of a storage resource to include:
a base firmware image representing a first firmware version of information handling resource; and
one or more firmware patch images comprising the firmware patch image, wherein each of the one or more firmware patch images includes differences between a given firmware version from which such firmware patch image was created and a previous firmware version.

3. The information handling system of claim 1, wherein the information handling resource comprises a management controller.

4. The information handling system of claim 2, the operations include: rolling back from a current firmware version to a previous firmware version by removing one or more of the one or more firmware patch images.

5. A method for managing firmware versions of an information handling resource comprising, in response to receiving a firmware update image:
comparing the new firmware version to an existing firmware version;
storing differences between the new firmware version and the existing firmware version as a firmware patch image; and
applying the firmware patch image to the existing firmware version to emulate the new firmware version, wherein applying the firmware patch image to the existing firmware version comprises overlaying a first file system associated with the new firmware version on a second file system associated with the existing firmware version, wherein an instance of a particular file present in the first file system takes precedence over an instance of the particular file in the lower layer.

6. The method of claim 5, further comprising maintaining a firmware partition of a storage resource to include:
a base firmware image representing a first version of firmware of the information handling resource; and
one or more firmware patch images comprising the firmware patch image, wherein each of the one or more firmware patch images includes differences between a given firmware update image from which such firmware patch image was created and a previous version of firmware of the information handling resource.

7. The method of claim 5, wherein the information handling resource comprises a management controller.

8. The method of claim 6, further comprising performing a rollback from a current firmware version to a previous firmware version by removing one or more of the one or more firmware patch images.

9. An article of manufacture comprising:
a non-transitory computer-readable medium; and
computer-executable instructions carried on the computer-readable medium, the instructions readable by a processor, the instructions, when read and executed, for causing the processor to manage firmware versions of an information handling resource by, in response to receiving a new firmware version:
compare the new firmware version to an existing firmware version;
store differences between the new firmware version and the existing firmware version as a firmware patch image; and
apply the firmware patch image to the existing firmware version to emulate the new firmware version, wherein applying the firmware patch image to the existing firmware version comprises overlaying a first file system associated with the new firmware version on a second file system associated with the existing firmware version, wherein an instance of a particular file present in the first file system takes precedence over an instance of the particular file in the lower layer.

10. The article of claim 9, the instructions for further causing the processor to manage firmware versions of an information handling resource by maintaining a firmware partition of a storage resource to include:
a base firmware image representing a first version of firmware of the information handling resource; and
one or more firmware patch images comprising the firmware patch image, wherein each of the one or more firmware patch images includes differences between a given firmware update image from which such firmware patch image was created and a previous version of firmware of the information handling resource.

11. The article of claim 9, wherein the information handling resource comprises a management controller.

12. The article of claim 10, the instructions for further causing the processor to rollback from a current firmware version to a previous firmware version by removing one or more of the one or more firmware patch images.
